(19) United States
(12) Patent Application Publication
(10) Pub. No.: US 2011/0211213 A1
(43) Pub. Date: Sep. 1, 2011

(54) Printing System, Print Data Generating Device, Multi-Function Device, and Non-Transitory Recording Medium

(75) Inventors: Tomoyuki KUBO, Nagoya-shi (JP); Hiroto SUGAHARA, Ama-shi (JP); Masayuki TAKATA, Nagoya-shi (JP)

(73) Assignee: BROTHER KOGYO KABUSHIKI KAISHA, Nagoya-shi (JP)

(21) Appl. No.: 13/032,748

(22) Filed: Feb. 23, 2011

(30) Foreign Application Priority Data
Feb. 26, 2010 (JP) 2010-041354

(51) Int. Cl. G06F 3/12; G06F 15/00

(52) U.S. Cl. 358/1.13; 358/1.15

(57) ABSTRACT

In a printing system, a print data generating unit generates print data of an original image that includes a first image and a bar code that stores a second image and a predetermined information piece. A first printing unit prints the original image on a first recording medium based on the print data. The predetermined information piece is to be written in the first recording medium for retrieving the second image from the bar code. A reading unit reads an image of the first recording medium on which the original image is printed. A controller determines whether the read image includes a written information piece that is written in the first recording medium and matches the predetermined information piece stored in the bar code. When the controller determines affirmatively, a second printing unit prints the second image retrieved from the bar code on a second recording medium.

### BACKGROUND OF THE INVENTION

1. Field of the Invention

The present application claims priority from Japanese Patent Application Publication No. JP-2010-041354, which was filed on Feb. 26, 2010, the disclosure of which is incorporated herein by reference in its entirety.

The present invention relates to a printing system and a multi-function device that are configured to print and read an image, and a print data generating device and a non-transitory recording medium for generating print data of an image.

2. Description of Related Art

A known information card, e.g., a business card, includes printed information, such as personal name, company name, and address. In addition, one or more bar codes are printed on the information card, and the bar codes store various information. For example, one of the bar codes stores the above-described printed information, and another bar code stores company information such as a line of products. A recipient of such information card is allowed to retrieve various information from the information card using a bar code reader.

### SUMMARY OF THE INVENTION

A need has arisen for a print data generating device and a non-transitory recording medium for generating print data of an image including a bar code from which information is retrieved only when a predetermined condition is satisfied. A need also has arisen for a printing system and a multi-function device configured to read an image printed based on such print data to retrieve the information from the bar code and to print the retrieved information on a recording medium.

According to an embodiment of the invention, a printing system comprises a print data generating unit, a first printing unit, a second printing unit, a reading unit, and a controller configured to control the second printing unit and the reading unit. The print data generating unit is configured to generate print data of an original image that includes a first image and a bar code that stores a second image and a predetermined information piece. The first printing unit is configured to print the original image on a first recording medium based on the print data. The predetermined information piece is to be written in the first recording medium for retrieving the second image from the bar code. The controller is configured to control the reading unit to read an image of the first recording medium on which the original image is printed, and is configured to determine whether the read image includes a written information piece that is written in the first recording medium and matches the predetermined information piece stored in the bar code. When the controller determines affirmatively, the controller is configured to control the second printing unit to print the second image retrieved from the bar code on a second recording medium.

According to another embodiment of the invention, a print image generating device comprises a print data generating unit configured to generate print data of an original image that includes a first image and a bar code that stores a second image and a predetermined information piece. The predetermined information piece is to be written in a first recording medium on which the original image is to be printed, for retrieving the second image from the bar code.

According to another embodiment of the invention, a multi-function device comprises a printing unit, a reading unit, and a controller configured to control the printing unit and the reading unit. The controller is configured to control the reading unit to read an image of a first recording medium on which an original image is printed, the original image including a first image and a bar code that stores a second image and a predetermined information piece. The controller is configured to determine whether the read image includes a written information piece that is written in the first recording medium and matches the predetermined information piece stored in the bar code, and when the controller determines affirmatively, the controller is configured to retrieve the second image from the bar code and control the printing unit to print the second image on a second recording medium.

According to another embodiment of the invention, a non-transitory recording medium stores a computer readable program that, if executed by a processor of a computer, causes the processor to execute generating print data of an original image that includes a first image and a bar code that stores a second image and a predetermined information piece. The predetermined information piece is to be written in a first recording medium, on which the original image is to be printed, for retrieving the second image from the bar code.

Other objects, features, and advantages will be apparent to persons of ordinary skill in the art from the following detailed description of the invention and the accompanying drawings.

### BRIEF DESCRIPTION OF THE DRAWINGS

For a more complete understanding of the invention, the needs satisfied thereby, and the features and technical advantages thereof, reference now is made to the following descriptions taken in connection with the accompanying drawings.

FIG. 1A shows a schematic view showing a multi-function device according to an embodiment of the invention.

FIG. 1B is a block diagram showing an electrical structure of the multi-function device of FIG. 1A.

FIG. 2 is a diagram showing control executed by a controller of the multi-function device.

FIG. 3A shows an image printed by the multi-function device.

FIG. 3B shows an image printed by the multi-function device based on the image of FIG. 3A.

FIG. 4 is a flowchart showing a procedure for printing the image of FIG. 3A.

FIG. 5 is a flowchart showing a procedure for printing the image of FIG. 3B.

FIG. 6 shows an image printed by the multi-function device based on the image of FIG. 3A, according to a first modification.

FIG. 7A shows an image printed by the multi-function device, according to a second modification.

FIG. 7B shows an image printed by the multi-function device based on the image of FIG. 7A, according to the second modification.

FIG. 8 shows an image printed by the multi-function device based on the image of FIG. 7A, according to a third modification.

FIG. 9 shows a diagram showing control executed by the control unit of the multi-function device, according to a fourth modification.

FIG. 10 is a flowchart showing a procedure for printing an image, according to the fourth modification.

FIG. 11 shows an image printed by the multi-function device based on the image of FIG. 3A, according to a sixth modification.

FIG. 12A shows an image printed by the multi-function device, according to a seventh modification.

FIG. 12B shows an image printed by the multi-function device based on the image of FIG. 12A, according to the seventh modification.

FIG. 13 is a flowchart showing a procedure for printing the image of FIG. 12B, according to the seventh modification.

FIG. 14A shows an image printed by the multi-function device, according to the eighth modification.

FIG. 14B shows an image printed by the multi-function device based on the image of FIG. 14A according to the eighth modification.

FIG. 15A shows an image printed by the multi-function device, according to the ninth modification.

FIG. 15B shows an image printed by the multi-function device based on the image of FIG. 15A, according to the eighth modification.

FIGS. 16A and 16B show images printed by the multi-function device depending on one of two passwords written in the image of FIG. 12A, according to a tenth modification.

FIG. 17A shows a schematic view showing a printing system comprising a multi-function device and a personal computer (PC), according to a twelfth modification.

FIG. 17B is a block diagram showing an electrical structure of the printing system of FIG. 17A.

FIG. 18 is a diagram showing control executed by the PC and the controller of the multi-function device.

FIG. 19 is a flowchart showing a procedure for generating print data of the image of FIG. 3A.

### DETAILED DESCRIPTION OF EMBODIMENTS

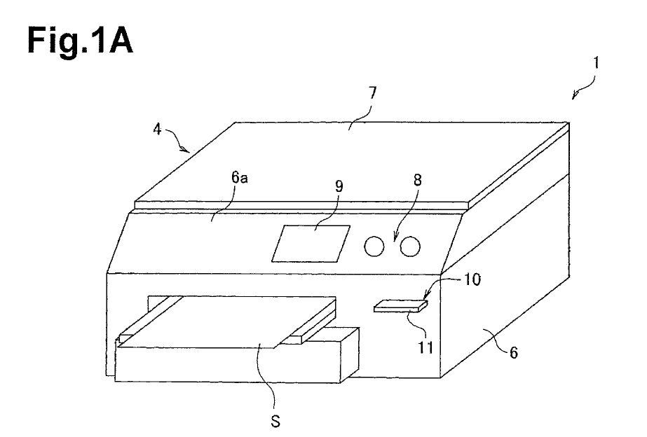

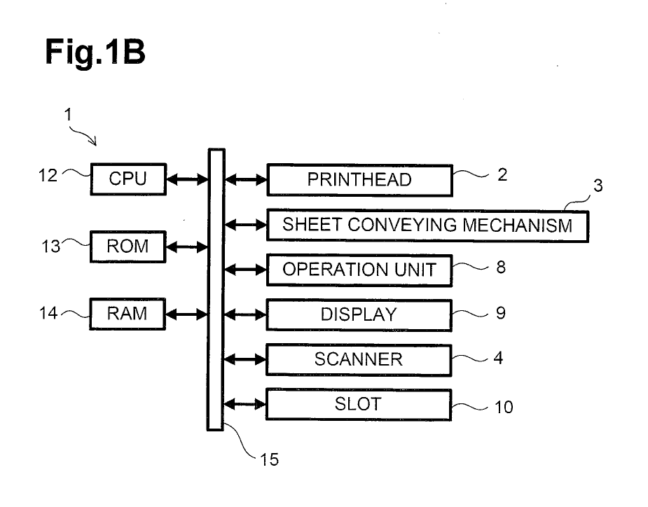

Embodiments of the invention and their features and technical advantages may be understood by referring to FIGS. 1-19, like numerals being used for like corresponding parts in the various drawings.

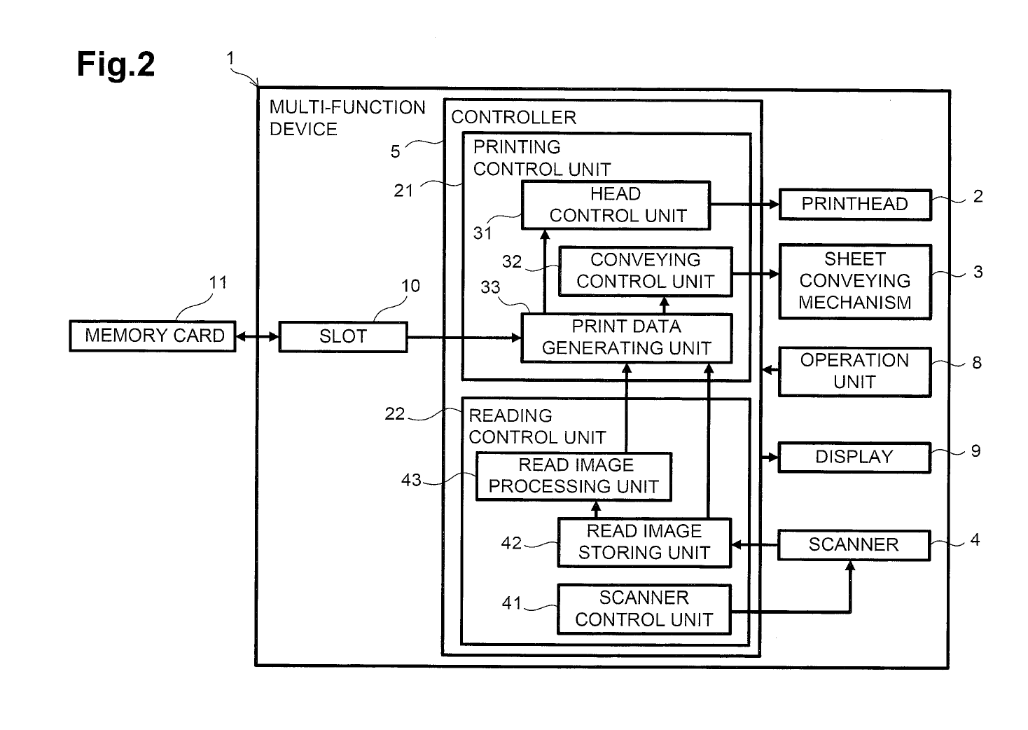

As shown in FIGS. 1 and 2, a multi-function device 1 according to an embodiment of the invention includes a printhead 2 that prints an image on a recording medium, such as a sheet S, a sheet conveying mechanism 3 that conveys the sheet S in a predetermined direction (forward in FIG. 1A), a scanner 4 that reads an image printed on the sheet S, and a controller 5 that controls the various mechanisms of the multi-function device 1, such as the printhead 2, the sheet conveying mechanism 3, and the scanner 4.

As shown in FIG. 1A, the multi-function device 1 has a substantially rectangular parallelepiped main body 6, in which the printhead 2, the sheet conveying mechanism 3, and so on are accommodated. The printhead 2 prints on the sheet S by a known method, such as an inkjet method, a laser method, or a thermal transfer method. The sheet conveying mechanism 3 is configured to convey the sheet S in a predetermined direction with a conveying roller that is rotationally driven by a motor.

The scanner 4 is provided at the top of the main body 6. As shown in FIG. 1A, the scanner 4 includes a glass original plate (not shown), a reading unit (not shown) disposed below the original plate, and a cover 7 that covers the upper surface of the original plate. The scanner 4 is configured to read an image printed on an original with the reading unit after the original is placed on the upper surface of the original plate, with the cover 7 closed.

An inclined surface 6a is formed at the upper part of the front of the main body 6. The inclined surface 6a is provided with an operation unit 8 having a plurality of operation buttons to be operated by a user and a display 9 that displays the operating state of the multi-function device 1, an error message, a content read from a bar code, to be described later, etc. The right of the front of the main body 6 is provided with a slot 10 in which a memory card 11 is to be inserted. Data, such as image data, recorded on the memory card 11 is retrieved in the slot 10 and is input to the controller 5.

For ease of explanation, image data is input from the memory card 11 to the multi-function device 1 via the slot 10; the input of image data to the multi-function device 1 is not limited thereto. For example, image data may be input to the multi-function device 1 through a cable that connects the multi-function device 1 and a digital camera. Alternatively, image data may be input from a mobile phone having a camera function to the multi-function device 1 via a radio communication using infrared rays or the like.

As shown in FIG. 1B, the multi-function device 1 comprises a central processing unit (CPU) 12, a read only memory (ROM) 13, a random access memory (RAM) 14, the printhead 2, the sheet conveying mechanism 3, the operation unit 8, the display 9, and the slot 10. These elements are electrically connected with one another via a bus 15. The CPU 12 collectively controls the multi-function device 1 and operates in accordance with programs and data stored in the ROM 22. The RAM 14 temporarily stores data processed by the CPU 12. The CPU 12, ROM 13, and RAM 14 function as the controller 5.

As shown in FIG. 2, the controller 5 comprises a printing control unit 21 and a reading control unit 22. The reading control unit 22 performs control when the scanner 4 reads an image and a bar code. The reading control unit 22 comprises a scanner control unit 41, a read image storing unit 42, and a read image processing unit 43.

The scanner control unit 41 controls the operation of the scanner 4 when it reads an image. The read image storing unit 42 temporarily stores an image read by the scanner 4. The read image processing unit 43 processes the image stored in the read image storing unit 42 to obtain an answer R and to retrieve data stored in a bar code B1, to be described later.

The printing control unit 21 performs control when the multi-function device 1 performs printing. The printing control unit 21 comprises a head control unit 31, a conveying control unit 32, and a print data generating unit 33. The head control unit 31 and the conveying control unit 32 control the printhead 2 and the sheet conveying mechanism 3, respectively, when the multi-function device 1 performs printing. The print data generating unit 33 generates print data of a print image based on, for example, image data recorded on the memory card 11 inserted in the slot 10, an image stored in the read image storing unit 42, and data retrieved from the bar code B1, to be described later, by the read image processing unit 43.

When a print instruction from the operation unit 8 is input by the user, an image is printed based on the image data input from the memory card 11, and another image is printed by reading the printed image, as will be described later.

The controller 5 displays the state (print state or standby state) of the multi-function device 1, an error message, etc. on the display 9 to notify the user of such information.

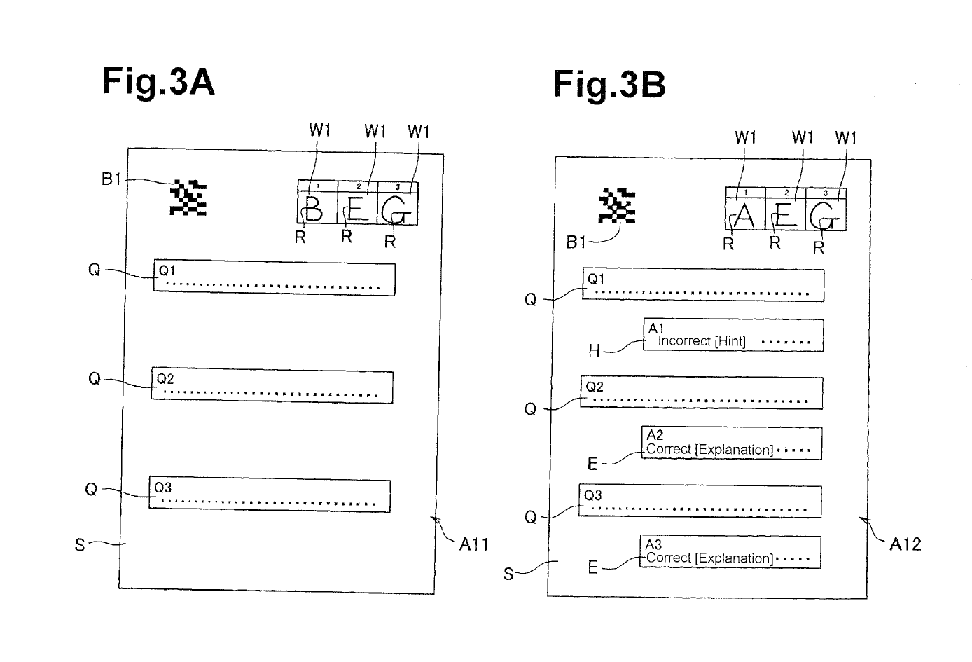

Next, an image printed by the multi-function device 1 and an image printed based on the printed image will be described. The multi-function device 1 prints, for example, an image A11 shown in FIG. 3A based on data recorded on the memory card 11 that is inserted in the slot 10. FIG. 3A is a diagram illustrating an example of the image printed by the multi-function device 1.

The image A11 in FIG. 3A is used for, for example, a written examination sheet and includes, as components of the image A11, three questions Q, three writing spaces W1, and the bar code B1. The three writing spaces W1 is served as a writing position indication image and indicate to the user where to write answers R to the three questions Q. As shown in FIG. 3A, the individual answers R are written in the frames of the three writing spaces W1.

The bar code B1 stores various kinds of data, e.g., the questions Q (first images), images of the writing spaces W1, an image of the bar code B1, correct answers (predetermined information pieces) to the questions Q, explanations E (second images) for the questions Q, and hints H (third images). The bar code B1 also stores print positions of the questions Q, the barcode B1, the writing spaces W1, the explanations E, and the Hints H. The explanations E are printed when the answers R written in the writing spaces W1 are correct, and the hints H are printed, instead of the explanations E, when the answers R written in the writing spaces W1 are incorrect (and also when the writing spaces W1 are blank), as will be described later.

Next, an image A12 that is printed based on the image A11 read by the scanner 4 will be described. FIG. 3B shows the image A12. This embodiment will be described when applied to a case in which correct answers R to three questions Q are “B”, “E”, and “G”, respectively, and “A”, “E”, and “G” are written in the writing spaces W1 as answers R to the three questions Q, in other words, an answer R to the uppermost question Q is incorrect, and answers R to the remaining two questions Q are correct. In FIG. 3B, although the answers R are printed for ease of understanding the drawing, the answers R may not be printed.

As shown in FIG. 3B, in the image A12, the same questions Q, writing spaces W1, and bar code B1 as those in the image A11 are disposed, explanations E corresponding to questions Q to which answers R written in the writing spaces W1 are correct are disposed below the questions Q, and an hint H is disposed, instead of an explanation E, below a question Q to which an answer R written in the writing space W1 is incorrect.

The image A12 is printed when the scanner 4 reads the image A11 in which answers R to the questions Q are written in the writing spaces W1. The image A12 allows the user to refer to explanation E for the questions Q to which correct answers R are given, and to give an answer to the question W again with reference to the hint H for the question Q to which the incorrect answer R is given.

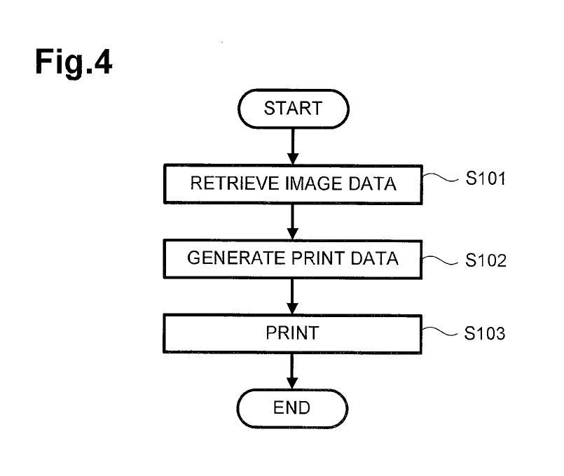

Next, a procedure for printing the image A11 shown in FIG. 3A will be described. FIG. 4 is a flowchart illustrating the procedure.

In order to print the image A11, the image data of the image A11 shown in FIG. 3A is prepared and is recorded on the memory card 11 in advance. More specifically, the data of the image A11 in which the questions Q, the writing spaces W1, and the bar code B1 are disposed, as shown in FIG. 3A, is generated using image editing software or the like and is recorded on the memory card 11.

As shown in FIG. 4, the image data of the image A11 is retrieved from the memory card 11 inserted in the slot 10 (step S101, hereinafter simply referred to as S101). Next, the print data generating unit 33 generates print data from the image data retrieved from the memory card 11 (S102), and an image is printed based on the generated print data (S103). Thus, the image A11, as shown in FIG. 3A, is printed on the sheet S.

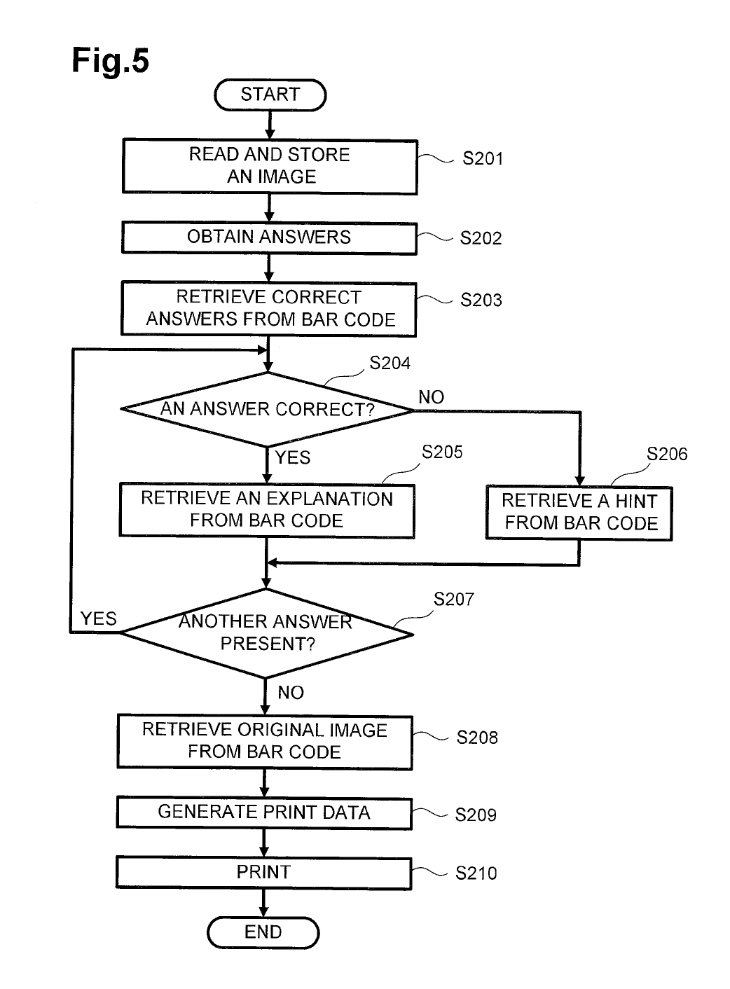

Next, a procedure for reading the image A11 and printing the image A12 based on the read image A11 will be described. FIG. 5 is a flowchart illustrating the procedure. Here, in this embodiment, before the image A11 is read by the scanner 4, the answers R to the questions Q are written in the writing spaces W1 with a pen or the like, as described above.

The image A11 in which the answers R are written is read by the scanner 4, and the read image A11 is stored in the read image storing unit 42 (S201).

Next, the answers R written in the writing spaces W1 are obtained by the read image processing unit 43 (S202), and information on correct answers is retrieved from the bar code B1 in the image A11 stored in the read image storing unit 42 (S203). Steps S202 and S203 may be reversed.

It is determined whether an answer R written in the writing space W1 matches the retrieved correct answer (S204). If they match, (S204: YES), a corresponding explanation E is retrieved from the bar code B1 (S205). If they do not match (S204: NO), a corresponding hint H is retrieved from the bar code B1 (S206).

The processes of S204 to S206 are performed on all of the answers R (S207: YES), and after completion of the processes of S204 to S206 on all the answers R (S207: NO), the components of the original image A11, including the questions Q, are retrieved from the bar code B1 (S208). Then, print data of the image A12 is generated by the print data generating unit 33 (S209) from the components of the original image A11 retrieved in S208 and the explanations E and the hint H retrieved in S205 and S206. The image A12 is printed based on the generated print data (S210). The retrieval of the components of the original image A11 in S208 may be performed in any step before the printing in S209.

By printing the image A12 as described above, the corresponding explanations E are printed only when the image A11 is read in a state in which correct answers are written in the writing spaces W1. On the other hand, when the image A11 is read with an incorrect answer written in any of the writing spaces W1 or when the image A11 is read with no answer written in any of the writing spaces W1, the hint H may be printed instead of the explanation E.

Since the image A11 is provided with the writing spaces W1, into which the answers R are written (the answers R are written only in specified positions), the answers R can be read accurately in S202.

Furthermore, since the bar code B1 stores the components of the image A11, including the questions Q, as well as the explanations E and the hints H, an image in which the questions Q, the explanation(s) E and/or the hint(s) H are disposed can be printed using the data stored in the bar code B1. The questions Q, the explanation(s) E and/or the hint(s) H can be printed on the same sheet S.

Next, modifications in which various changes are made to the above-described embodiment will be described. Descriptions of elements having the same configurations as those of the above-described embodiment are omitted as appropriate.

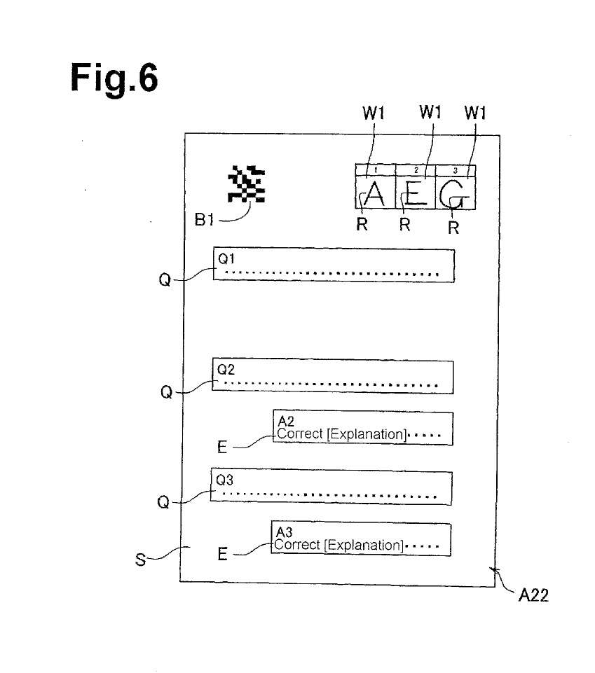

In a modification (a first modification), information on the hints H are not stored in the bar code B1. When the answers R written in the writing spaces W1 include an incorrect answer, an image A22 is printed, as shown in FIG. 6, in which corresponding explanations E are disposed below questions Q to which correct answers R are given, while the space below a question Q to which an incorrect answer R is given is blank.

Also in this case, the explanations E to the questions Q can be printed only when the answers R written in the writing spaces W1 are correct. Accordingly, the user can recognize that the answer R is incorrect by confirming that nothing is printed below the question Q.

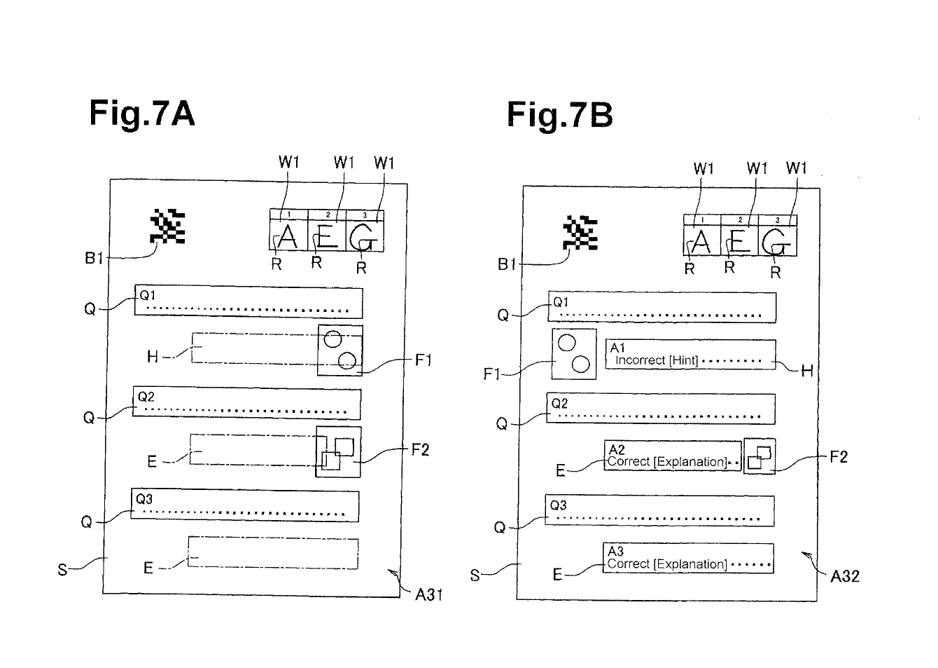

In another modification (a second modification), as shown in FIG. 7A, an image A31 includes related figures F1 and F2 that are related to and disposed below the first and second questions Q respectively from the top. The related figures F1 and F2 and the print positions thereof are stored in the bar code B1. As indicated by the one-dot-one-dash line in FIG. 7A, the related figures F1 and F2 are disposed in the image A31 at positions overlapping with the explanation E and the hint H to be printed in an image A32 in FIG. 7B. The image A32 is printed when the image A31 is read by the scanner 4. In the second modification, the image A31 includes, as the first images, the questions Q and the related figures F1 and F2.

When the answers R are written in the writing spaces W1 of the image A31, and the image A31 is read by the scanner 4, the image A32 in which the explanations E and the hint H are added to the image A31 is printed, as shown in FIG. 7B, as in the foregoing embodiment. However, in the image A32, the related figure F1 is disposed to the left from the position in the image A31 (the related figure F1 is changed in position), and the related figure F2 is scaled down, and the related figures F1 and F2 do not overlap with the explanation E and the hint H.

In this case, although the related figure F1 stored in the bar code B1 is the same as that disposed in the image A31, the related figure F2 stored in the bar code B1 is scaled down to be disposed in the image A32. The positions of the related figures F1 and F2 stored in the bar code B1 indicate the positions of the related figures F1 and F2 in the image A32 shifted and scaled down from those in the image A31.

Accordingly, print data is generated in S209 (FIG. 5) such that the related figures F1 and F2 do not overlap with the explanation E and the hint H.

In this modification, although the related figure F1 is simply shifted in position, and the related figure F2 is simply scaled down, the related figures F1 and F2 may be scaled down and shifted in position.

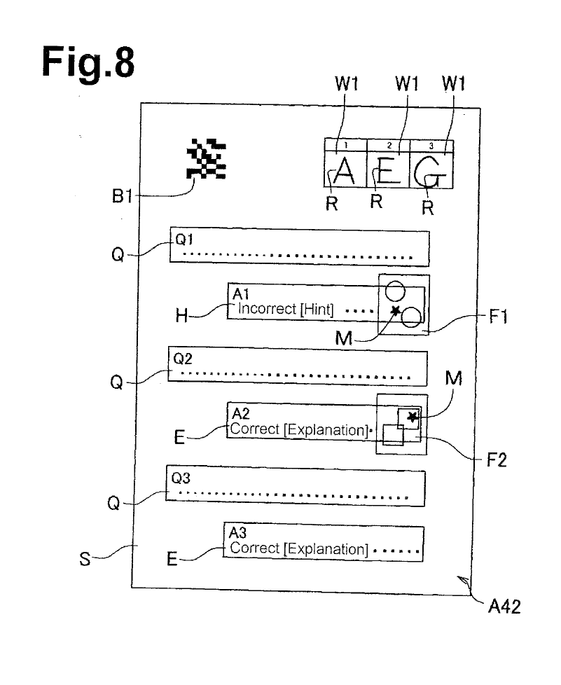

In the second modification, the related figures F1 and F2 are printed so as not to overlap with the explanation E and the hint H; however, as shown in FIG. 8, if the explanation E and the hint H each include a mark M to be added to the related figure F1 or F2, an image A42 may be printed such that the related figures F1 and F2 overlap with the explanation E and the hint H (a third modification).

In the second modification, although the positions of the related figures F1 and F2 that are disposed in the image A31 are changed, the present invention is not limited thereto. For example, if the user write a note at a position below any of the questions Q in the image A11 of FIG. 3A, in addition to writing the answers R in the writing spaces, the position of the note may be changed when the image A12 shown in FIG. 3B is printed (a fourth modification).

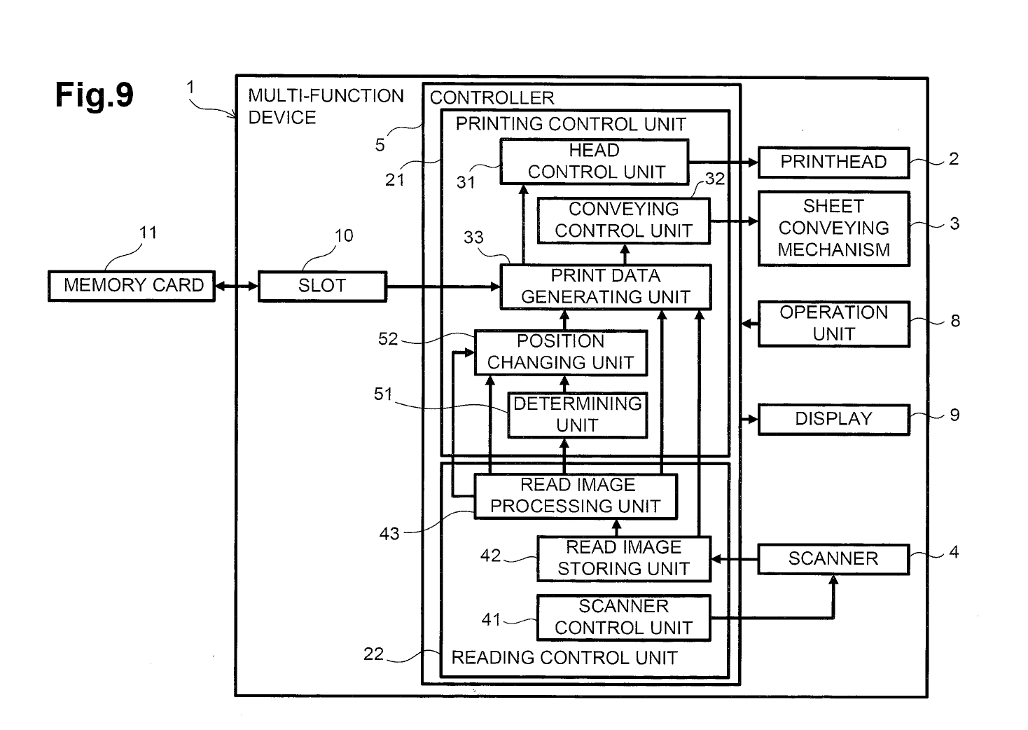

In this case, for example, the read image processing unit 43 is configured to detect the position of a note other than the answers R if present in an image stored in the read image storing unit 42. Furthermore, as shown in FIG. 9, the printing control unit 21 further comprises a determining unit 51 and a position changing unit 52. The determining unit 51 determines whether the note overlaps with any of the explanations E and the hint H from the position of the note detected by the read image processing unit 43 and the positions of the explanations E and the hint H stored in the bar code B1. The position changing unit 52 changes the print position of the note when the determining unit 51 determines that the note overlaps with the explanation E or the hint H. The print data generating unit 33 generates print data of an image in which the note is disposed at a position changed by the position changing unit 52.

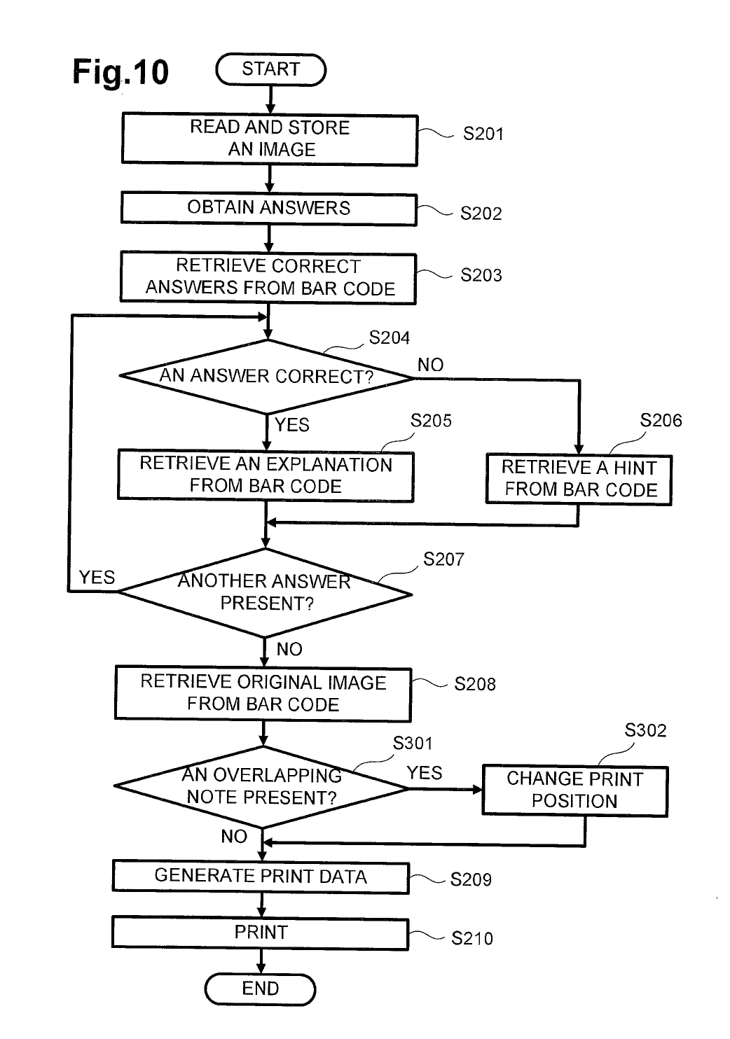

In this case, as shown in FIG. 10, after S208 described above, the determining unit 51 determines whether a note that overlaps with any of the explanations E and the hint H is written in the image A11 (S301). If such a note is present (S301: YES), the position changing unit 52 changes the print position of the note (S302), and the process moves to S209. On the other hand, when the determining unit 51 determines that a note that overlaps with any of the explanations E and the hint H is not present in the image A11 (S301: NO), the process moves directly to S209 described above.

Although, in the foregoing embodiment, the bar code B1 stores the questions Q, the image of the bar code B1, and the images of the writing spaces W1, which are the components of the image A11, the present invention is not limited thereto. For example, the bar code B1 may not store such components, and print data of the image A12 may be generated in S209 from the explanation E and the hint H retrieved from the bar code B1 and the read image A11 (a fifth modification).

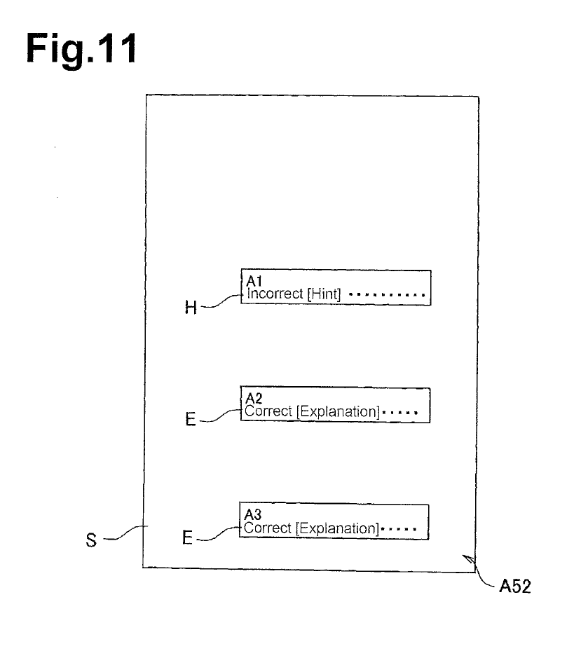

Alternatively, as shown in FIG. 11, an image A52 may be printed in which only the explanations E and the hint H are disposed, and in which the questions Q, the bar code B1, and the writing spaces W1, which are the components of the image A11, are not printed (a sixth modification).

Although, in the forgoing embodiment, the explanation E or the hint H is printed below each question Q depending on whether the answers R written in the writing spaces W1 are correct, items to be printed below the questions Q are not limited thereto. For example, items other than the explanation E and the hint H may be printed below the questions Q; for example, only a simple explanation may be printed below a question Q to which a correct answer R is given, and a more detailed explanation may be printed below a question Q to which an incorrect answer R is given, or alternatively, only a message indicating whether the answer R is correct or incorrect may be printed below each question Q.

Although the above is applied to printing a sheet used for a writing examination or the like in which answers R to questions Q are written in the writing spaces W1, the present invention is not limited thereto; the present invention may be applied to printing of various kinds of sheets.

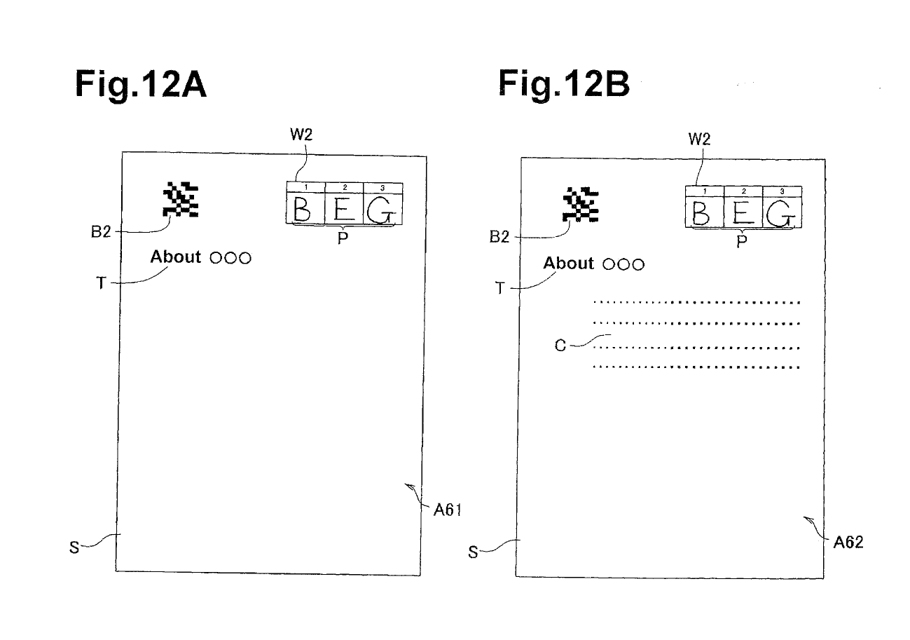

For example, according to another modification (a seventh modification), as shown in FIG. 12A, an image A61 printed based on data retrieved from the memory card 11 inserted in the slot 10 is used for a secret document and includes, as components of the image A61, a title T, a writing space W2, and a bar code B2. The title T is related to a content C printed in an image A62, to be described later.

The writing space W2 is served as a writing position indicating image and indicates the user where to write a password P. In the seventh modification, a correct password P is composed of three characters “BEG”, so that the writing space W2 is divided into three regions. The three characters of the password P are written in the three regions of the writing space W2 in one-to-one correspondence.

The bar code B2 stores various kinds of data, e.g., the title T (a first image), an image of the writing space W2, an image of the bar code B2, the content C (a second image) and the password (a predetermined information piece). Here, the content C is, for example, high secret information related to the title T. The bar code B2 also stores the print positions of the title T, the writing space W2, the bar code B2, and the content C.

When the image A61 in which a correct password P is written in the writing space W2 is read by the scanner 4, an image A62 is printed as shown in FIG. 12B. The image A62 includes the content C disposed below the title T and the components of the image A61. If the password P written in the writing space W2 does not match the password stored in the bar code B2, the same image as the image A61 shown in FIG. 12A is printed without change.

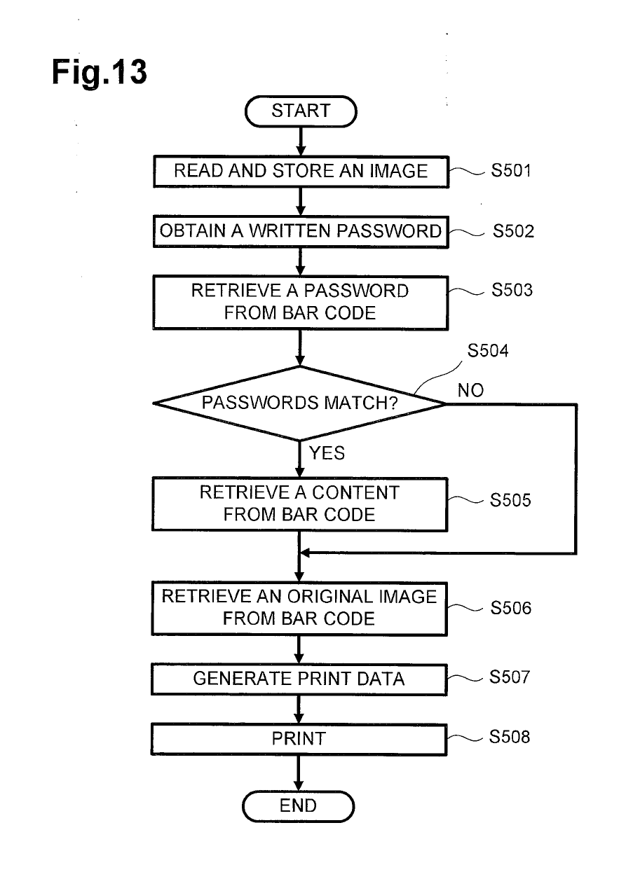

In this case, as shown in FIG. 13, the image A61 in which the password P is written in the writing space W2 is read by the scanner 4, and the read image A61 is stored in the read image storing unit 42 (S501). The written password P is obtained by the read image processing unit 43 from the image A61 stored in the read image storing unit 42 (S502), and the password is retrieved from the bar code B2 (S503). If the obtained password P and the retrieved password match (S504: YES), the content C is retrieved from the bar code B2 (S505), and the components of the original image A61, i.e., the title T, the writing space W2, and the bar code B2, are retrieved from the bar code B2 (S506). On the other hand, if the passwords do not match (S504: NO), only the components of the original image A61 are retrieved from the bar code B2 (S506).

Next, the print data generating unit 33 generates print data from the data retrieved in S505 and S506 described above (S507), and an image is printed based on the generated print data (S508).

By performing printing as described above, the content C, such as secret information, can be printed only when the image A61 is read in a state in which the correct password P is written in the writing space W2. This can prevent the high secret content C from being retrieved by a third person who does not know the password.

Furthermore, since the password P is written in the position indicated by the writing space W2 provided in the image A61 (is written only in a specified position), the password P can be accurately recognized in S502 described above.

Since the bar code B2 stores the components of the image A61, including the title T, the image A62 in which the title T and the content C related to the title T are disposed can be printed using the data stored in the bar code B2. The title T and the content C can be printed on the same sheet S.

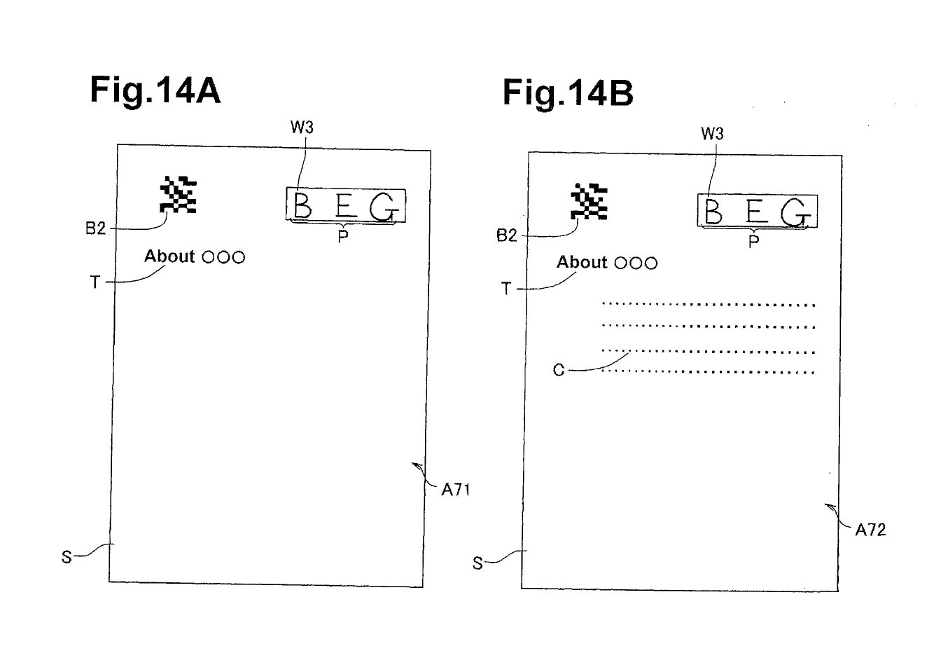

Furthermore, although, in the seventh modification, the writing space W2 is divided into three regions so that the individual characters of the password P are to be written therein, it is not limited thereto. For example, as shown in FIG. 14A, a not-divided writing space W3 may be provided in an image A71, and only when all the three characters of the password P, “BEG”, are written in the writing space W3, an image A72 in which the content C is disposed may be printed, as shown in FIG. 14B (an eighth modification). This can prevent the number of digits of the password from being revealed to a third person.

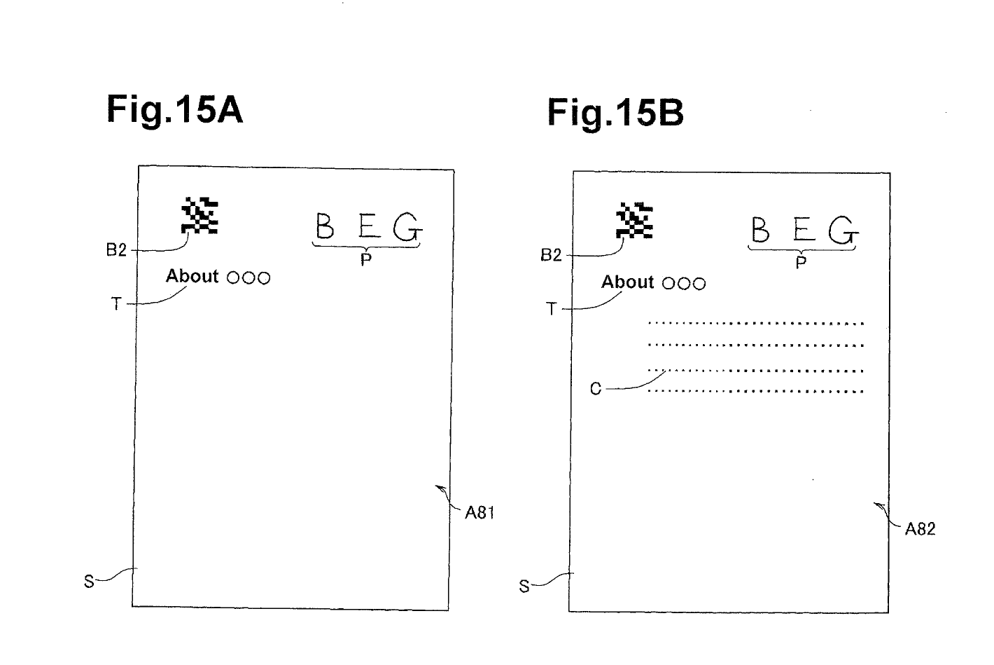

Furthermore, as shown in FIG. 15A, an image A81 may have no writing space indicating the writing position of the password P, and only when a correct password P is written in a predetermined position or any position of the sheet S on which the image A81 is printed, an image A82 in which the content C is disposed may be printed, as shown in FIG. 15B (a ninth modification). In the cases of the eighth and ninth modifications, the number of digits of the password P is not limited to three and may be two or less or four or greater.

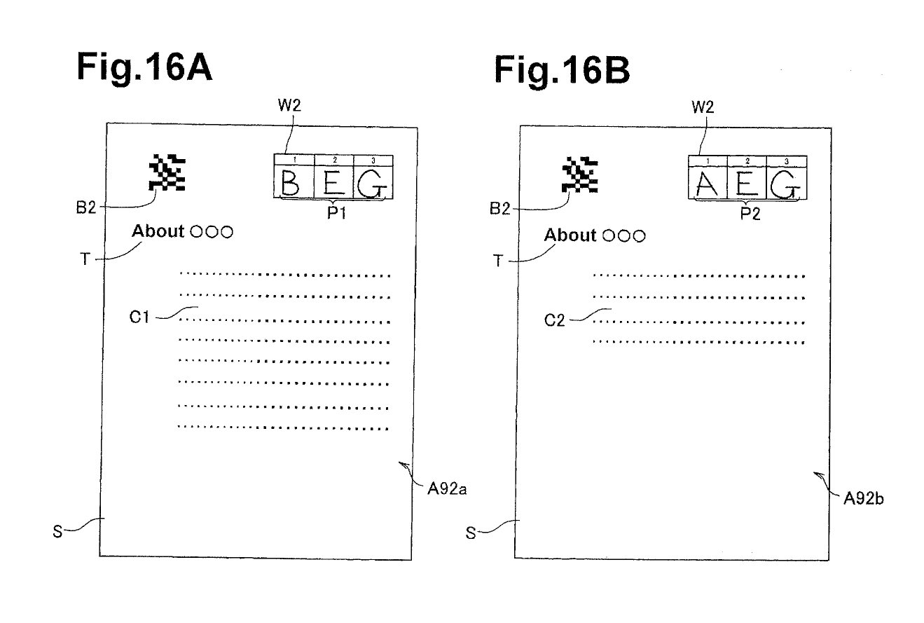

Although, in the seventh modification, only one password P and one content C are stored in the bar code B2, the present invention is not limited thereto. For example, two kinds of passwords P1 and P2, which serve as predetermined information pieces, and two kinds of contents C1 and C2, which serve as second images, may be stored in the bar code B2. Only when an image A61 in which the password P1 is written in the writing space W2 is read by the scanner 4, an image A92a in which the content C1 is disposed is printed, as shown in FIG. 16A, and only when an image A61 in which the password P2 is written in the writing space W2 is read by the scanner 4, an image A92b in which the content C2 is disposed is printed, as shown in FIG. 16B (a tenth modification). FIG. 16A shows a case where the password P1 is “BEG”, and FIG. 16B shows a case where the password P2 is “AEG”.

In this case, either of the contents C1 and C2 stored in the bar code B2 can be selectively printed depending on a password written in the writing space W2. Although, in the tenth modification, two kinds of contents C1 and C2 and two kinds of passwords P1 and P2 are stored in the bar code B, three or more kinds of contents and three or more kinds of passwords may be stored in the bar code B2.

In the seventh modification, if the written password P does not match the password stored in the bar code B2, the image A61 is printed without change; however, the present invention is not limited thereto. For example, a low-secrecy content may be stored in the bar code B2, as a third image, in addition to the high-secrecy content C. If the passwords do not match (including a case in which no password is written), an image in which the low-secrecy content is disposed instead of the content C may be printed (an eleventh modification).

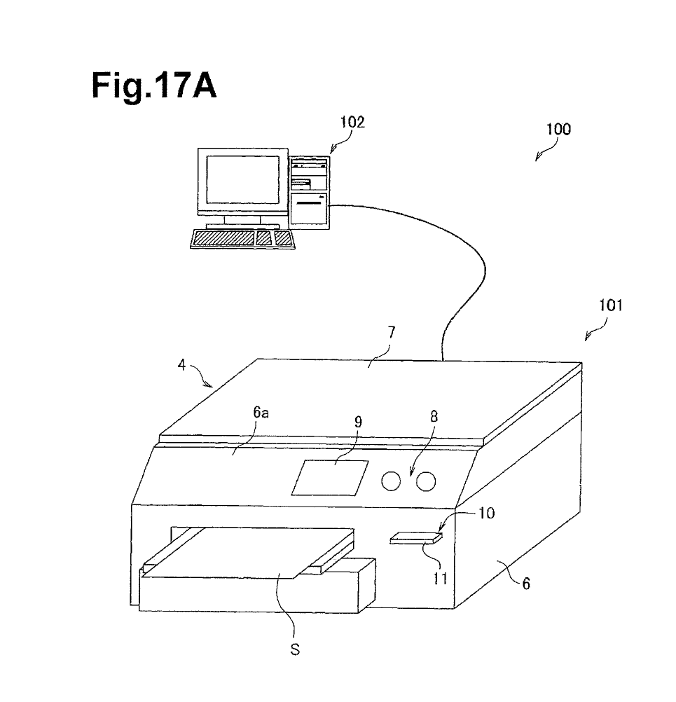

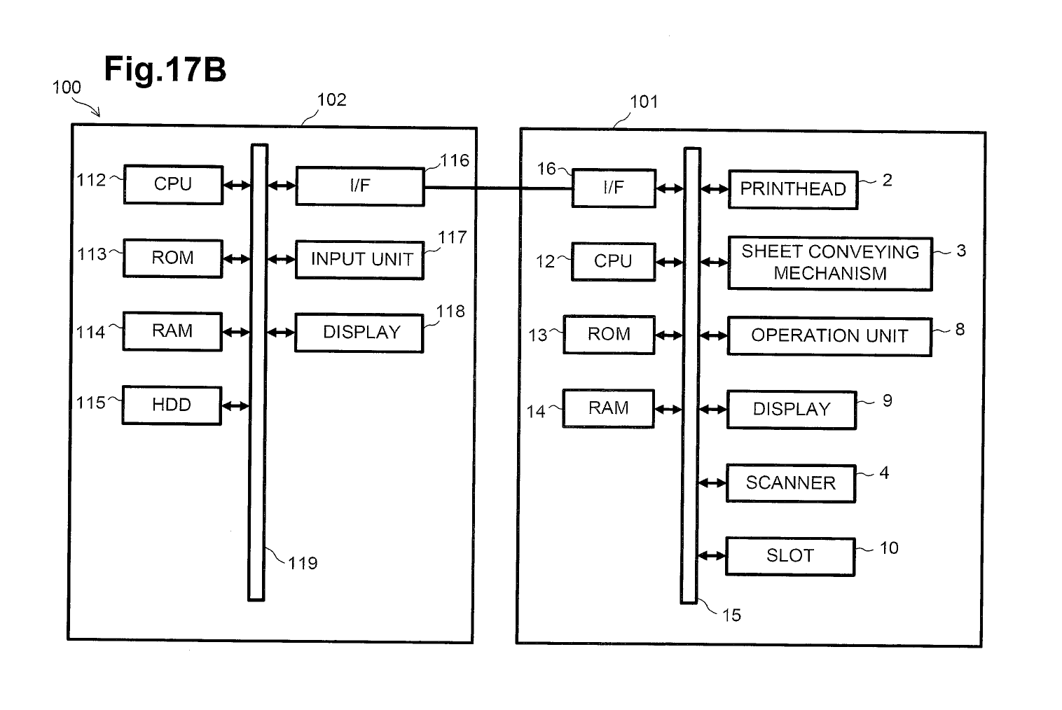

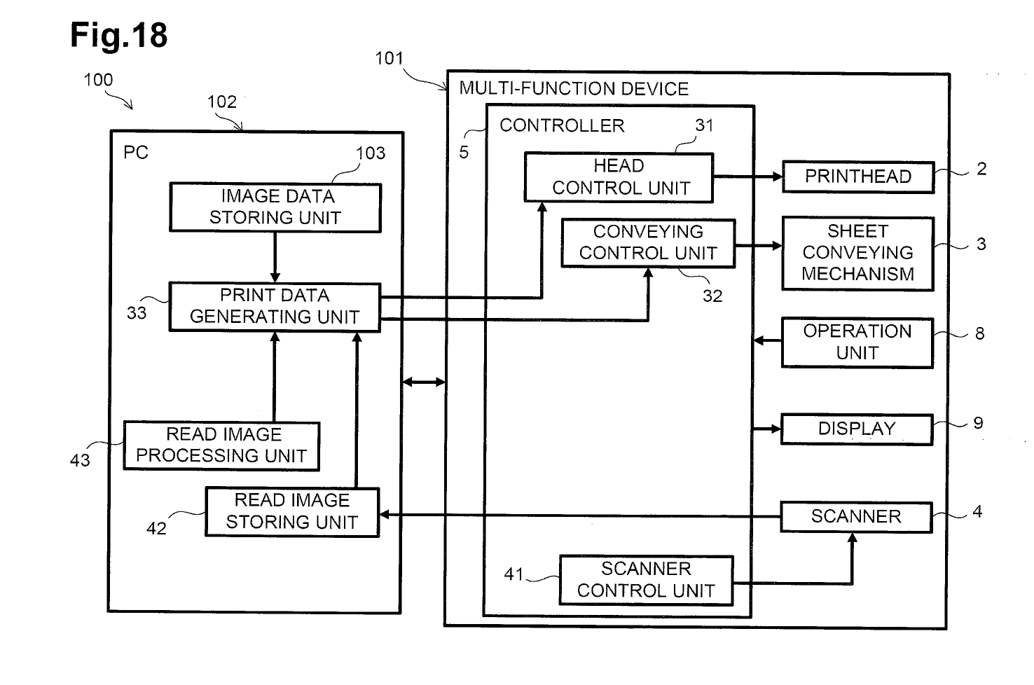

Although, in the above examples, all the processes are performed in the multi-function device 1, the present invention is not limited thereto. In another modification (a twelfth modification), a multi-function device 101 and a personal computer (PC) 102 are connected to configure a print system 100, as shown in FIGS. 17A, 17B and 18. As shown in FIG. 17B, the PC 102 comprises a central processing unit (CPU) 112, a read only memory (ROM) 113, a random access memory (RAM) 114, a hard disc drive (HDD) 115, an interface (I/F) 116, an input device 117, and a display 118, and these elements are electrically connected via a bus 119. The PC 102 and the multi-function device 101 are electrically connected via interfaces (I/F) 16, 116. The HDD 115 is a mass storage device that stores various application programs to be executed by the CPU and various kinds of data including image data.

The CPU 112, ROM 113, RAM 114, and HDD 115 of the PC 102 function as the image data storing unit 103, print data generating unit 33, read image processing unit 43, and read image storing unit 42. The CPU 12, ROM 13, and RAM 14 of the multi-function device 101 function as the head control unit 31, conveying control unit 32, and scanner control unit 41.

In the twelfth modification, the PC 102 comprises a print data generating unit 33, a read image storing unit 42, a read image processing unit 43, and an image data storing unit 103 that is configured by the above-described mass storage device and stores image data of, for example, the image A11, to be read by the scanner 4. The print data generating unit 33 generates print data based on image data stored in the image data storing unit 103, an image stored in the read image storing unit 42, and the processing result of the read image processing unit 43. On the other hand, the multi-function device 101 has a configuration in which the print data generating unit 33, the read image storing unit 42, and the read image processing unit 43 are excluded from the multi-function device 1 (see FIGS. 1 and 2).

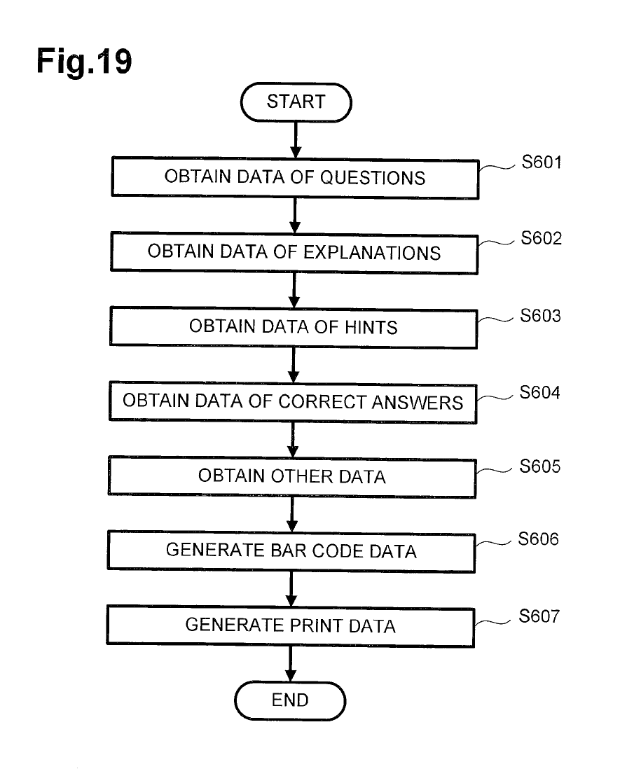

The print data generating unit 33 of the PC 102 may generate print data of the image A11 (FIG. 3A) by carrying out the procedure shown in FIG. 19. The print data generating unit 33 may obtain data of the questions Q in S601, data of the explanations E in S602, data of the hints H in S603, data of the correct answers in S604, and other data necessary for generating image data of the bar code B1 and print data of the image A11 in S605. Then, the print data generating unit 33 may generate image data of the bar code B1 based on the obtained data in S606, and generate print data of the image A11 in S607. Alternatively, the print data generating unit 33 of the controller 5 of the multi-function device 1 (FIG. 2) may generate print data of the image A11 in a similar manner. Or, these steps S601-S607 may be carried out by a print image generating device other than the PC 102 and the multi-function device 1.

Further, a non-transitory recording medium storing a computer-readable program may be installed in a computer so that the program is executed by a processor of the computer to cause the processor to generate print data of image A11 (FIG. 3A).

The twelfth modification offers substantially the same operational advantages as those of the foregoing embodiment, although part of the processes is performed by the PC 102 in the twelfth modification. As in the foregoing embodiment, only when the same (such as answer R and password P) as those stored in the bar code is written in the original image, the second image (such as the explanation E and content C) that is stored in the bar code and is not printed in the original image can be printed.

Although, in the twelfth modification, the PC 102 comprises the print data generating unit 33, the read image storing unit 42, and the read image processing unit 43, the multi-function device 101 may comprise one or some of these units.

In the forgoing embodiment and modifications, the image A11 and image A12 are printed by the same device, e.g., the multi-function device 1 or the multifunction device 101 of the printing system 100. Nevertheless, the image A11 may be printed by a different device from the device that prints the image A12.

While the invention has been described in connection with embodiments of the invention, it will be understood by those skilled in the art that variations and modifications of the embodiments described above may be made without departing from the scope of the invention. Other embodiments will be apparent to those skilled in the art from a consideration of the specification or practice of the invention disclosed herein. It is intended that the specification and the described examples are considered merely as exemplary of the invention, with the true scope of the invention being defined by the following claims.

What is claimed is:

1. A printing system comprising:
a print data generating unit configured to generate print data of an original image that includes a first image and a bar code that stores a second image and a predetermined information piece;
a first printing unit configured to print the original image on a first recording medium based on the print data, wherein the predetermined information piece is to be written in the first recording medium for retrieving the second image from the bar code;
a second printing unit;
a reading unit; and
a controller configured to control the second printing unit and the reading unit, wherein the controller is configured to:
control the reading unit to read an image of the first recording medium on which the original image is printed,
determine whether the read image includes a written information piece that is written in the first recording medium and matches the predetermined information piece stored in the bar code,
retrieve the second image from the bar code and control the second printing unit to print the second image on a second recording medium when the controller determines that the read original image includes the written information piece.

2. The printing system according to claim 1, wherein the original image further includes a writing position indicating image that indicate a position for writing the written information piece in the first recording medium.

3. The printing system according to claim 1,
wherein the bar code stores plural kinds of second images and plural kinds of predetermined information pieces that correspond to the plural kinds of second images respectively, and
wherein the controller is configured to:
determine whether the read image includes the written information piece that is written in the first recording medium and matches any one of the plural kinds of predetermined information pieces stored in the bar code, and
retrieve a corresponding one of the plural kinds of second images from the bar code and control the second printing unit to print the corresponding one of the plural kinds of second images on the second recording medium when the controller determines that the read image includes the written information piece.

4. The printing system according to claim 1,
wherein the bar code further stores a third image, and
wherein the controller is configured to retrieve the third image from the bar code, instead of the second image, and to control the second printing unit to print the third image on the second recording medium when the controller determines that the read image dose not include the written information piece.

5. The printing system according to claim 4,
wherein the first image represents a question, and
wherein the bar code stores the second image associated with a correct answer to the question, the predetermined information piece representing the correct answer, and the third image associated with an incorrect answer to the question.

6. The printing system according to claim 1, wherein the bar code further stores the first image, a bar code image, and print positions of the first image, the bar code image, and the second image.

7. A print data generating device comprising:
a print data generating unit configured to generate print data of an original image that includes a first image and a bar code that stores a second image and a predetermined information piece,
wherein the predetermined information piece is to be written in a first recording medium on which the original image is to be printed, for retrieving the second image from the bar code.

8. The print data generating device according to claim 7, further comprising:
a printing unit configured to print the original image on the first recording medium based on the print data.

9. The print data generating device according to claim 7, wherein the original image further includes a writing position indicating image that indicate a position for writing the predetermined information piece in the first recording medium.

10. The print data generating device according to claim 7,
wherein the first image represents a question, and
wherein the bar code stores the second image associated with a correct answer to the question, and the predetermined information piece representing the correct answer.

11. A multi-function device comprising:
a printing unit;
a reading unit; and
a controller configured to control the printing unit and the reading unit, wherein the controller is configured to:
control the reading unit to read an image of a first recording medium on which an original image is printed, the original image including a first image and a bar code that stores a second image and a predetermined information piece,
determine whether the read image includes a written information piece that is written in the first recording medium and matches the predetermined information piece stored in the bar code,
retrieve the second image from the bar code and control the printing unit to print the second image on a second recording medium when the controller determines that the read image includes the written information piece.

12. The multi-function device according to claim 11, wherein the controller is configured to control the printing unit to print the original image printed on the first recording medium, in addition to the second image, on the second recording medium.

13. The multi-function device according to claim 11, wherein the controller is configured to control the printing unit to print the first image printed on the second recording medium at a position not overlapping with the second image.

14. The multi-function device according to claim 13, wherein the controller is configured to control the printing unit to print the first image on the second recording medium while scaling down at least a part of the first image.

15. The multi-function device according to claim 13, wherein the controller is configured to control the printing unit to print the first image on the second recording medium while changing a position of at least a part of the first image.

16. A non-transitory recording medium storing a computer readable program that, if executed by a processor of a computer, causes the processor to execute:
generating print data of an original image that includes a first image and a bar code that stores a second image and a predetermined information piece,
wherein the predetermined information piece is to be written in a recording medium on which the original image is to be printed, for retrieving the second image from the bar code.

17. The non-transitory recording medium according to claim 16, wherein the original image further includes a writing position indicating image that indicate a position for writing the predetermined information piece in the recording medium.

18. The non-transitory recording medium according to claim 16,
wherein the first image represents a question, and
wherein the bar code stores the second image associated with a correct answer to the question, and the predetermined information piece representing the correct answer.
